(19) United States
(12) Patent Application Publication
(10) Pub. No.: US 2009/0114117 A1
(43) Pub. Date: May 7, 2009

(54) Leveling agent and water-based floor-polishing composition comprising the leveling agent

(75) Inventors: Takashi Tokuue, Kanagawa (JP); Tetsuya Sayama, Kanagawa (JP); Yasunori Terunuma, Kanagawa (JP); Mikio Akimoto, Kanagawa (JP); Haruyoshi Miyauchi, Chiba (JP)

Correspondence Address: OLIFF & BERRIDGE, PLC, P.O. BOX 320850, ALEXANDRIA, VA, 22320-4850, US

(73) Assignee: Toho Chemical Industry Co., Ltd., Tokyo (JP)

(21) Appl. No.: 11/660,740

(22) PCT Filed: Aug. 25, 2004
(86) PCT No.: PCT/JP2004/012210

§ 371 Date: Jun. 25, 2008

(51) Int. Cl. C09G 1/00; C09G 1/04; C09G 1/08; C09G 1/16

(52) U.S. Cl. 106/10; 106/311; 106/3; 524/376

(57) ABSTRACT

A leveling agent for water-based floor polishes which contains a nonionic surfactant, characterized in that the nonionic surfactant is at least one member selected from the group consisting of compounds represented by the general formula (1): R¹—C(R²)H—CH₂O—(C₂H₄O)ₘ(C₃H₆O)ₙ—H [wherein R¹ represents C₄₋₁₀ alkyl; R² represents C₆₋₁₂ alkyl; m is an integer of 1 to 10; n is an integer of 0 to 6; and the ethylene oxide unit(s) and the propylene oxide unit(s) are bonded in any desired sequence, i.e., in either block or random arrangement] and compounds represented by the general formula (II): R³O—(C₂H₄O)ₚ(C₃H₆O)_{q}—H [wherein R³ represents at least one residue of one or more aliphatic alcohols selected among 3,5,5-trimethylhexanol, isooctyl alcohol, isodecyl alcohol, isoundecyl alcohol, and isotridecyl alcohol; p is an integer of 0 to 8 and q is an integer of 0 to 8, provided that p+q is an integer of 2 to 8; and the ethylene oxide unit(s) and the propylene oxide unit(s) are bonded in any desired sequence, i.e., in either block or random arrangement].

### TECHNICAL FIELD

The present invention relates to a leveling agent which is useful as a component for a water-based floor-polish. The present invention relates also to a water-based floor-polishing composition comprising the leveling-agent, which composition is excellent in a leveling property, gloss, water resistance property and storage stability.

### BACKGROUND ART

Water-based polishes generally find broad applications. For example, they are used for protecting various items, for polishing to maintain beautiful appearance, as floor polishes for domestic uses or for commercial facilities including supermarkets, department stores and hotels and, furthermore, for exterior coating on structures such as buildings and bridge beams, or as mold release agents. Coated films formed by applying a water-based polish on the surface need to have excellent properties such as gloss, water resistance property, acid resistance, alkali resistance, weather resistance, anti-abrasion, and adhesion. In particular, floor polishes that are used on flooring materials need to have properties of preventing abrasion of the floor materials, deposition of stains and slipping accidents as well as properties of maintaining beautiful appearance and cleanliness feeling by a polishing effect.

A leveling agent is used for a leveling ability to provide an even gloss entirely on a coated surface without causing streaking, after applying a floor polish. Conventional water-based floor polishes contain tris-butoxyethyl phosphate (hereinafter referred to as TBEP) as a leveling agent. However, because TBEP is a phosphorus compound, there is a concern that it may have adverse effects on an ecosystem if it leaks to the environment.

Typical examples of the water-based floor polishes are disclosed, for example, in the following Patent Document 1, Patent Document 2, JIS (Japanese Industrial Standards) K3920 (Method for Testing floor Polishes), and JFPA (Japan Floor Polish Industrial Association) Standards. According to these, water-based floor polishes comprise a leveling agent, an emulsion polymerized resin emulsion, an emulsion of wax, an alkali-soluble resin, a plasticizer, a solvent, and a surface active compound. All of or a part of these are combined in an appropriate ratio, and then these components cause interactions with each other to have properties required in a specific application. Some compounds are added in the water-based floor polishes to improve the properties, such as alkoxylated linear aliphatic alcohols disclosed in Patent Documents 3 and 8, adipic acid esters disclosed in Patent Document 4, N-methyl-2-pyrrolidone disclosed in Patent Document 5, alkylcarboxylic acids disclosed in Patent Document 6, and polyethoxylated aliphatic alcohols disclosed in Patent Document-7. However, these compounds have a high risk of giving adverse effects on a human body and ecosystem, if they leak into the environment. There is not known a floor polish which has a satisfactory leveling property, gloss, water resistance, and storage stability without using these compounds.

Patent Document 1: Japanese Patent Publication S44 [1969]-24407

Patent Document 2: Japanese Patent Publication S49 1974]-1458

Patent Document 3: Japanese Patent Publication H6 1994]-23335

Patent Document 4: Japanese Patent Application Laid-Open H6 [1994]-80933

Patent Document 5: Japanese Patent Application Laid-Open 2001-302990

Patent Document 6: Published Translation of PCT Application 2002-506479

Patent Document 7: Japanese Patent Application Laid-Open H6 [1994]-33016

Patent Document 8: U.S. Pat. No. 4,131,585

### DISCLOSURE OF THE INVENTION

### Problems to Be Solved by the Invention

An object of the present invention is to provide a water-based floor polish having sufficient performances in a leveling property, gloss, water resistance, and storage stability, without using compounds that may have a high risk of giving adverse effects on a human body and ecosystem if they leak into the environment.

### Means to Solve the Problems

The present invention provides a leveling agent for a water-based floor polish, comprising a nonionic surfactant, characterized in that the nonionic surfactant is at least one member selected from the group consisting of compounds represented by the following general formula (I):

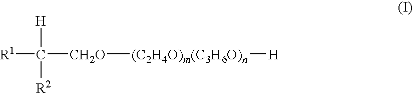

wherein R¹ represents an alkyl group having 4 to 10 carbon atoms, R² represents an alkyl group having 6 to 12 carbon atoms, m is an integer of from 1 to 10 and n is an integer of from 0 to 6, wherein the ethylene oxide unit(s) and the propylene oxide unit(s) may be bonded in any desired sequence in either block or random arrangement, and

compounds represented by the following general formula (II):

R³O—(C₂H₄O)ₚ(C₃H₆O)_{q}—H (II)

wherein R³ represent at least one residue of one or more aliphatic alcohols selected from the group consisting of 3,5,5-trimethyl hexanol, isooctyl alcohol, isodecyl alcohol, isoundecyl alcohol, and isotridecyl alcohol; p is an integer of from 0 to 8 and q is an integer of from 0 to 8, a total of p and q being 2 to 8; and the ethylene oxide unit(s) and the propylene oxide unit(s) may be bonded in any desired sequence in either block or random arrangement, and

also provides a water-based floor-polishing composition containing the aforesaid leveling agent.

### BEST MODES FOR CARRYING OUT THE INVENTION

The present invention will be explained in detail below.

In the aforementioned general formula (I), R¹ represents an alkyl group having 4 to 10 carbon atoms, preferably 4 to 8 carbon atoms, and more preferably 4 to 6 carbon atoms, and R² represents an alkyl group having 6 to 12 carbon atoms, preferably 6 to 10 carbon atoms, and more preferably 8 to 10 carbon atoms. R¹ and R² each can be only one kind of the alkyl group, or a combination of two or more of these alkyl groups. R¹ and R² may be a residue of 2-butyldecanol, 2-hexyloctanol, 2-hexyldecanol, 2-octyldecanol, 2-hexyldodecanol, 2-octyldodecanol, and 2-decyltetradecanol.

In the aforementioned general formula (I), m specifies the number of mols of ethylene oxide units added and is an integer of 1 to 10, preferably 2 to 8, and more preferably 3 to 5. n specifies the number of mols of propylene oxide units added and is an integer of 0 to 6, preferably 1 to 5, and more preferably 2 to 4. In the aforementioned general formula (II), p specifies the number of mols of ethylene oxide units added and is an integer of 0 to 8, preferably 1 to 8, and more preferably 2 to 6. q specifies the number of mols of propylene oxide units added and is an integer of 0 to 8, preferably 0 to 6, and more preferably 1 to 5.

Performances such as a leveling ability, gloss, water resistance and storage stability can be improved by adding to a floor polish a leveling agent comprising a nonionic surfactant represented by the aforementioned general formula (I) or (II) where ethylene oxide and/or propylene oxide are added to branched aliphatic alcohol. Because these nonionic surfactants contain no phosphorus, there is no adverse effect on a ecosystem if they leak into the environment, so that they can be used desirably in water-based floor polishes.

In the water-based floor-polishing composition, the amount of the at least one nonionic surfactant selected from the aforementioned general formulas (I) and (II) ranges from 0.1 to 15 percent by weight.

An emulsion polymerized resin emulsion obtained by emulsion polymerization of at least one ethylenically unsaturated monomer may be added to the water-based floor-polishing composition of the present invention in an amount of 5 to 60 wt. %, calculated as a solid, preferably 10 to 30 wt. %, whereby a further homogeneous coated surface can be obtained.

The emulsion polymerized resin emulsion can be obtained by emulsion polymerizing, in a known method, at least one monomer selected from C₁ to C₈ alkylacrylates and methacrylates such as ethyl acrylate, propyl acrylate, butyl acrylate, isobutyl acrylate, octyl acrylate, dodecyl acrylate, 2-ethylhexyl acrylate, methyl methacrylate, ethyl methacrylate, propyl methacrylate, ethylhexyl methacrylate, and butyl methacrylate, mono- and di- (C₁ to C₅) alkylitaconates and fumarates, maleic anhydride, vinylidene chloride, styrene, m-methylstyrene, o-methylstyrene, p-methylstyrene, p-phenylstyrene, p-chlorostyrene, dichlorostyrene, vinyltoluene, acrylonitrile, methacrylonitrile, acrylamide, methacrylamide, acrylic acid, methacrylic acid, itaconic acid, fumaric acid, citraconic acid, crotonic acid, beta-acryloxypropionic acid, and hydroxy (C₁ to C₆) alkylacrylates and methacrylates.

In a case where an MFT (minimum film forming temperature) of the aforementioned emulsion polymerized resin emulsions ranges from 50° C. to 85° C., preferably from 55° C. to 80° C., a floor-polishing composition with excellent stain resistance can be obtained. A polymerized resin emulsion with an MFT of less than 50° C. can be used for the purpose of anti-slipping, if needed. However, if all of the polymers used have an MFT of less than 50° C., strong tackiness and reduced soil resistance take place, which is undesirable. When using a polymerized resin emulsion having an MFT of less than 50° C., it is desirable to use, together, a polymerized resin emulsion having an MFT of 50° or higher in a proportion of 30 wt. % or greater relative to the resin portion in the polymerized resin emulsion.

The water-based floor-polishing composition of the present invention may further contains an emulsion of polyolefin having a carboxyl group with a mean particle size of 20 to 500 nm, preferably 20 to 300 nm, whereby a coated film strength can be improved. The emulsion of polyolefin having a carboxyl group can be manufactured, in a variety of emulsion methods, from a raw material olefin wax having an added carboxyl group, such as oxidized polyethylene wax, oxidized polypropylene wax, acid-modified polyethylene wax, and acid-modified polypropylene wax.

A particle size of the emulsions obtained depends upon the emulsification method, kind and amount of a surfactant used, and affects properties and stability of the floor-polish. If the mean particle size of the emulsions obtained by emulsification under pressure is greater than 500 nm, the stability of the water-based polish is poor and the gloss of the coating is poor. If an emulsion having an emulsion particle size less than 20 nm is to be produced, the amount of the surfactant must be increased, which results in reduced water resistance of the polish prepared.

The leveling agent of the present invention is preferably used in an amount ranging from 1 to 20 wt. %, more preferably 5 to 15 wt. %, relative to a solid of the emulsion polymerized resin emulsion. In this range, sufficient leveling performance can be achieved and reduction in durability can be avoided.

The present water-based floor-polishing composition may further contain various additives, besides those mentioned above, such as alkali-soluble resins, nonionic or anionic dispersants, wetting agents, alkaline compounds, transition metal crosslinking agents, waxes, plasticizers, film formation auxiliaries such as glycolic solvents, triazine or thiazoline antiseptics, and silicone and fluorine defoaming agents. This invention will be illustrated below with reference to the Examples, but the present invention shall not be limited by these Examples. In these Examples, the MFT was measured according to JIS K6828-2.

### EXAMPLES

### Examples 1 through 7

The chemical compounds with the general formula (I) as shown in Table 1 (Synthetic Examples 1 through 7) and comparative chemical compound 2 were prepared.

### Synthesis Examples

Ethylene oxide (EO) and propylene oxide (PO) were added to the branched aliphatic alcohols shown in Table 1 at 160° C. to 170° C. and at 130° C. to 140° C., respectively, using caustic potash as a catalyst. The alcohols used and the mole number of ethylene oxide and propylene oxide added are as shown in Table 1 below.

TABLE 1

| | | Mole of EO | Mole of PO |
|---|---|---|---|
| | Alcohol | added | added |
| Synthesis Ex. 1 | 2-hexyldodecanol | 3 | 1 |
| Synthesis Ex. 2 | 2-butyldecanol | 3 | 1 |
| Synthesis Ex. 3 | 2-butyldecanol | 3 | 3 |
| Synthesis Ex. 4 | 2-hexyldecanol | 3 | 0 |
| Synthesis Ex. 5 | 2-hexyldecanol | 3 | 1 |
| Synthesis Ex. 6 | 2-hexyldecanol | 3 | 3 |
| Synthesis Ex. 7 | 2-hexyldecanol | 5 | 0 |
| Comparison | Tridecanol | 3 | 0 |
| Compound 2 | | | |

Comparison Compound 1: TBEP (tris-butoxyethyl phosphate)

<Preparation of Floor Polishes>

Water-based floor-polishing compositions were prepared with the following formulations, using the nonionic surfactants prepared in Synthesis Examples 1 through 7, Comparison Compound 1 (TBEP) and Comparison Compound 2 shown in Table 1 as a leveling agent. These are referred to as Examples 1 through 7 and Comparison Examples 1 and 2.

| | | |
|---|---|---|
| 1. | Ion exchanged water | 48.2% |
| 2. | Leveling agent | 1.3% |
| 3. | Diethyleneglycol monoethylether | 5.3% |
| | (Film formation auxiliary, ex Union Carbide) | |
| 4. | FC-129 | 1.0% |
| | (Wetting agent, 1% aq., ex Ciba Specialty Chemicals) | |
| 5. | DuraPlus-2 | 36.8% |
| | (Emulsion polymerized emulsion (styrene acrylic type, | |
| | MFT: 58° C.) 38% aq, ex Rohm and Haas) | |
| 6. | Hitech E4000 | 7.4% |
| | (Oxidized polyethylene wax, mean particle size: 70 nm, | |
| | 40% aq, ex Toho Chemical Industry Co., Ltd.) | |
| 7. | SE-21 | 0.01% |
| | (Defoaming agent, 17% aq, ex Wacker Silicones, sold by | |
| | Sanyo Trading) | |

The raw materials 1 through 4 were placed in a mixing vessel at room temperature and stirred for 10 minutes. Subsequently, the raw materials 5 and 6 were added and stirred for 10 minutes. Then, the raw material 7 was added and stirred for 10 minutes. The mixture was filtered through a 150 mesh filter and left standing for 24 hours or more to obtain a floor-polishing composition.

The resultant water-based floor-polishing compositions were subjected to the following tests. The results are as shown in Table 2.

### <Leveling Test>

The test was conducted according to JIS K3920-21.

### <Gloss Test>

The test was conducted according to JIS K3920-15. The results shown in Table 2 were those examined after the third application

### <Peeling Test>

The test was conducted according to JIS K3920-20.

<Repeated coating Test>

The test was conducted according to JIS K3920-22.

### <Water Resistance Test>

The test was conducted according to JIS K3920-18.

### <Storage Stability Test>

The test was conducted according to JIS K3920-13.

TABLE 2

| | | Items | | | | | |
|---|---|---|---|---|---|---|---|
| | | | | | Repeated | | |
| | | Leveling | | Peeling | coating | Water | Storage |
| Examples | | ability | Gloss | ability | ability | resistance | stability |
| Example | 1 | Excellent | 60 | Excellent | Excellent | No clouding | Passed |
| | 2 | Excellent | 65 | Excellent | Excellent | No clouding | Passed |
| | 3 | Excellent | 65 | Excellent | Excellent | No clouding | Passed |
| | 4 | Excellent | 55 | Excellent | Excellent | No clouding | Passed |
| | 5 | Excellent | 60 | Excellent | Excellent | No clouding | Passed |
| | 6 | Excellent | 60 | Excellent | Excellent | No clouding | Passed |
| | 7 | Excellent | 55 | Excellent | Excellent | No clouding | Passed |
| C* | 1 | Excellent | 60 | Excellent | Excellent | No clouding | Passed |
| | 2 | Poor | 45 | Excellent | Excellent | No clouding | Passed |

C* Comparison Example

As clearly seen from the results in Table 2, the water-based floor polishes containing the leveling agents of the present invention (Examples 1 through 7) exhibited the excellent leveling ability, gloss, peeling ability, repeated coating ability, water resistance, and storage stability.

### Examples 8 through 14

The chemical compounds with the general formula (II) as shown in Table 3 (Synthetic Examples 8 through 14) and comparison compounds 3 to 5 were prepared.

### Synthesis Examples

Ethylene oxides (EO) and propylene oxides (PO) were added to the aliphatic alcohols shown in Table 3 at 160° C. to 170° C. and at 130° C. to 140° C., respectively, using caustic potash as a catalyst, which products were neutralized to be used as samples. The used alcohols, the order of addition and mole number of ethylene oxide and propylene oxide added, and the arrangement of the addition were as shown in Table 3 below.

TABLE 3

| | | The order of introduction | | | Total mole | |
|---|---|---|---|---|---|---|
| | | of EO and PO and the mole | | | of the | Arrangement |
| | | number of addition | | | addition | of the |
| | Alcohols | EO | PO | EO | (p + q) | addition |
| Synthesis No. 8 | Isooctyl alcohol | 2 | 4 | 2 | 8 | Block |
| Synthesis No. 9 | 3,5,5-trimethylhexyl | — | 3 | 3 | 6 | Random |
| | alcohol | | | | | |
| Synthesis No. 10 | Isodecyl alcohol | — | 2 | 2 | 4 | Block |
| Synthesis No. 11 | Isodecyl alcohol | 2 | 2 | — | 4 | Block |
| Synthesis No. 12 | Isodecyl alcohol | — | 1 | 2 | 3 | Random |
| Synthesis No. 13 | Isoundecyl alcohol | — | 2 | 4 | 6 | Block |
| Synthesis No. 14 | Isotridecyl alcohol | — | 1 | 3 | 4 | Block |
| Comparison | Isohexyl alcohol | — | 3 | 3 | 6 | Block |
| Compound 3 | | | | | | |
| Comparison | Isodecyl alcohol | 4 | 2 | 4 | 10 | Block |
| Compound 4 | | | | | | |
| Comparison | Lauryl alcohol | — | — | 6 | 6 | Block |
| Compound 5 | | | | | | |

Preparation of an Emulsion Polymerized Resin Emulsion

430 g of ion exchanged water, 13 g of Alscope AP-30, 4 g of Lenox S-100 (both anionic surfactants ex Toho Chemical Industry Co., Ltd.), and 5 g of Pegnol L-20 (nonionic surfactant supplied by Toho Chemical Industries) were placed in a glass reactor equipped with a thermometer, a stirrer, a dropping funnel, a nitrogen introduction pipe, and a reflux condenser and, after flushed with nitrogen, heated. When the temperature reached 70° C., 1 g of potassium persulfate was added and, subsequently, a monomer mixture consisting of 130 g of styrene, 30 g of methyl methacrylate, 60 g of butyl acrylate, and 20 g of methacrylic acid were added dropwise using the dropping funnel over a period of 2 hours to polymerize, with supplement of another 1 g of potassium persulfate midway. Subsequently, the reaction mixture was maintained at about 75 to 80° C. for 2 hours. After cooling, an emulsion was obtained, an MFT of which was 55° C.

Preparation of an Emulsion of Polyolefin Having a Carboxyl Group

300 g of oxidized polyethylene (m.p. 135 C, density 0.93) (Tradename: AC-300, ex Allied Chemicals), 650 g of ion exchanged water, each 30 g of Pegnol D-208, Pegnol D-210 and Pegnol D-214 (all nonionic surfactants, ex Toho Chemical Industry Co., Ltd.) (each 30 g) and 10 g of 48% potassium hydroxide were placed in an emulsification equipment with a capacity of 1.5 liters equipped with a thermometer, a stirrer, and a temperature controller and, after flushed with nitrogen gas, stirred at a high speed at 160° C. for 2 hours to emulsify, which was subsequently cooled to give an sample. The mean particle size was 120 nm.

<Preparation of a Water-Based Floor Polish>

Water-based floor-polishing compositions were prepared with the following formulations, using the nonionic surfactants prepared in Synthesis Examples 8 through 14, Comparison Compounds 3 to 5 shown in Table 3, and Comparison Compound 1 (TBEP) as a leveling agent. These are referred to as Examples 8 through 14 and Comparison Examples 3 through 6.

| | | |
|---|---|---|
| 1. | Ion exchanged water | 48.2% |
| 2. | Leveling agent | 1.3% |
| 3. | Diethyleneglycol monoethylether | 5.3% |
| | (ex Union Carbide) | |
| 4. | FC-129 | 1.0% |
| | (Wetting agent, 1% aq., ex Chiba Specialty Chemicals) | |
| 5. | Emulsion polymerized resin emulsion obtained above | 36.8% |
| 6. | Emulsion of polyolefin having a carboxyl group | 7.4% |
| | obtained above | |
| 7. | SE-21 | 0.01% |
| | (Defoaming agent, 17% aq, ex Wacker Silicones, sold | |
| | by Sanyo Trading) | |

The raw materials 1 through 4 were placed in a mixing vessel at room temperature and stirred for 10 minutes. Subsequently, the raw materials 5 and 6 were added and stirred for 10 minutes. Then, the raw material 7 was added and stirred for 10 minutes. The mixture was filtered through a 150 mesh filter and left standing for 24 hours or more to obtain a floor-polishing composition.

The resultant water-based floor-polishing compositions were subjected to the following tests. The results are as shown in Table 4.

### <Leveling Test>

The test was conducted according to JIS K3920-21.

### <Heel Marking Resistance Test>

The test was conducted according to JIS K3920-16.

### <Water Resistance Test>

The test was conducted according to JIS K3920-18.

### <Gloss Test>

The test was conducted according to JIS K3920-15.

### <Recoating Test>

The test was conducted according to JIS K3920-22.

### <Storage Stability Test>

The test was conducted according to JIS K3920-13.

TABLE 4

| | | | Heel | | | Repeated | |
|---|---|---|---|---|---|---|---|
| Examples | | Leveling | marking | Water | | coating | Storage |
| No. | | ability | resistance | resistance | Gloss | ability | stability |
| Example | 8 | Excellent | Excellent | No clouding | 60 | Excellent | Passed |
| No. | 9 | Excellent | Excellent | No clouding | 65 | Excellent | Passed |
| | 10 | Excellent | Excellent | No clouding | 65 | Excellent | Passed |
| | 11 | Excellent | Excellent | No clouding | 60 | Excellent | Passed |
| | 12 | Excellent | Excellent | No clouding | 55 | Excellent | Passed |
| | 13 | Excellent | Excellent | No clouding | 60 | Excellent | Passed |
| | 14 | Excellent | Excellent | No clouding | 60 | Excellent | Passed |
| C* | 3 | Poor | Poor | Clouding | 50 | Excellent | Passed |
| | 4 | Mediocre | Slightly | Clouding | 55 | Excellent | Passed |
| | | | poor | | | | |
| | 5 | Poor | Slightly | Clouding | 60 | Excellent | Passed |
| | | | poor | | | | |
| | 6 | Excellent | Excellent | No clouding | 60 | Excellent | Passed |

C* Comparison Example

As clearly seen from the results in Table 4, the water-based floor polishes comprising the leveling agents of the present invention (Examples 8 through 14) exhibited excellent leveling ability, heel marking resistance, water resistance, gloss, repeated coating ability, and storage stability.

### INDUSTRIAL APPLICABILITY

The leveling agent of the present invention provides the water-based floor polishes having the excellent leveling ability, gloss, water resistance, and storage stability. The leveling agent also has the advantage that it gives less burden on the environment, and is safer.

1. A leveling agent for a water-based floor polish, comprising a nonionic surfactant, characterized in that the nonionic surfactant is at least one member selected from the group consisting of compounds represented by the following general formula (I): 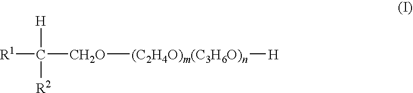
wherein R¹ represents an alkyl group having 4 to 10 carbon atoms, R² represents an alkyl group having 6 to 12 carbon atoms, m is an integer of from 1 to 10 and n is an integer of from 0 to 6, wherein the ethylene oxide unit(s) and the propylene oxide unit(s) may be bonded in any desired sequence in either block or random arrangement, and compounds represented by the following general formula (II):
R³O—(C₂H₄O)ₚ(C₃H₆O)_{q}—H (II)
wherein R³ represent at least one residue of one or more aliphatic alcohols selected from the group consisting of 3,5,5-trimethyl hexanol, isooctyl alcohol, isodecyl alcohol, isoundecyl alcohol, and isotridecyl alcohol; p is an integer of from 0 to 8 and q is an integer of from 0 to 8, a total of p and q being 2 to 8; and the ethylene oxide unit(s) and the propylene oxide unit(s) may be bonded in any desired sequence in either block or random arrangement.

2. A water-based floor-polishing composition containing the leveling agent as described in claim 1.

3. The water-based floor-polishing composition as described in claim 2, wherein a content of said at least one nonionic surfactant selected from the general formulas (I) and (II) is 0.1 to 15 wt. %.

4. The water-based floor-polishing composition as described in claim 2, wherein the composition contains 5 to 60 wt. %, as a solid content, of an emulsion polymerized resin emulsion obtained by emulsion polymerization of at least one ethylenically unsaturated monomer.

5. The water-based floor-polishing composition as described in claim 4, wherein a ratio by weight of the leveling agent to the solid content of said emulsion polymerized resin emulsion is in a range of from 1:100 to 20:100.

6. The water-based floor-polishing composition as described in claim 4, wherein the emulsion polymerized resin emulsion has an MFT (minimum film-forming temperature) ranging from 50° C. to 85° C.

7. The water-based floor-polishing composition as described in claim 2, wherein the composition further comprises an emulsion of polyolefin having a carboxyl group with a mean particle size ranging from 20 to 500 nm.

8. The water-based floor-polishing composition as described in claim 2 wherein the composition further comprises at least one of alkali-soluble resins, dispersants, surfactants other than said (I) and (II), alkaline compounds, waxes, plasticizers and transition metal cross-linking agents.

9. Use of the nonionic surfactant represented by the general formula (I) or (II) as described in claim 1 for improving the leveling ability of the water-based floor polishes.
